(19) United States
(12) Patent Application Publication
(10) Pub. No.: US 2009/0226101 A1
(43) Pub. Date: Sep. 10, 2009

(54) SYSTEM, DEVICES, METHOD, COMPUTER PROGRAM PRODUCT

(75) Inventor: Simon Lessing, Malmo (SE)

Correspondence Address: HARRITY & HARRITY, LLP, 11350 RANDOM HILLS ROAD, SUITE 600, FAIRFAX, VA, 22030, US

(73) Assignee: SONY ERICSSON MOBILE COMMUNICATIONS AB, Lund (SE)

(21) Appl. No.: 12/099,359

(22) Filed: Apr. 8, 2008

Related U.S. Application Data
(60) Provisional application No. 61/033,874, filed on Mar. 5, 2008.

(51) Int. Cl. G06K 9/72

(52) U.S. Cl. 382/229

(57) ABSTRACT

A system for transferring data displayed on a display of a provider device to a requester device. The requester device comprises a camera to capture data displayed on at least part of the display and a transmitter that is arranged to transmit a trigger signal to the provider device to inform the provider device that the camera is capturing, or about to capture data, from at least part of its display. The provider device comprises a cybercode-like pattern generator that is arranged to display a cybercode-like pattern on the display instead of or as well as the originally displayed data while the camera is capturing data from at least part of the display, whereby the camera will thereby capture at least part of the cybercode-like pattern instead of or as well as at least part of the originally displayed data. The system comprising an analyzer that is arranged to analyze the captured part of the cybercode-like pattern to determine which part of the display the camera captured data from, and to send a selection signal to: the provider device, the selection signal indicating which part of the display the camera captured data from, and the provider device is arranged to then send data originally displayed on that part of the display to the requester device.

### RELATED APPLICATION

This application claims priority under 35 U.S.C. §119 based on U.S. provisional application Ser. No. 61/033,874, filed Mar. 5, 2008, the disclosure of which is hereby incorporated by reference herein in its entirety.

### TECHNICAL FIELD

The present invention generally relates to transferring data between a provider device and a requester device.

### BACKGROUND OF THE INVENTION

Transferring data to/between devices, such as mobile phones, is often perceived as a cumbersome technical process that often requires Bluetooth pairing, cables, Wi-Fi accessibility, etc.

When users want to transfer data, such as text or image data, that is displayed on a display means, such as a computer monitor, to a mobile phone that includes a camera, users may simply capture an image of that data on the display means. Images captured by a camera phone may, however, be blurred or otherwise of poor quality, thereby compromising the data of interest from the captured image. Furthermore, only visual data may be transferred using such a technique. It is not, for example, currently possible to transfer the contents of a file, such as a music file, or a computer program that is represented by an icon on a display device, simply by imaging the display device.

### SUMMARY OF THE INVENTION

Embodiments of the present invention provide a system for transferring data between electronic devices.

According to one embodiment, a system may include a requester device and a provider device including a display, for example, a visual display device such as a screen or monitor. The requester device may include a camera unit, for example, an image-capturing device, to capture data displayed on at least part of the display of the provider device and a transmitter that is arranged to transmit a trigger signal to the provider device to inform the provider device that the camera unit is capturing, or about to capture data, from at least a portion of its display.

The provider device may include a cybercode-like pattern generator that is arranged to display a cybercode-like pattern on the display instead of or in addition to the originally displayed data while the camera is capturing data from at least a portion of the display. The trigger signal may be used to synchronize the camera and the cybercode-like pattern generator to ensure that a cybercode-like pattern is displayed on the display of the provider device while the camera is capturing data therefrom. The camera may capture at least a portion of the cybercode-like pattern instead of or in addition to at least a portion of the originally displayed data.

Cybercode may include a visual tagging system based on a two-dimensional (“2D”) barcode technology. Cybercode tags can be recognized by camera devices, for example, by the inexpensive CMOS or CCD cameras that are currently included in many commercially available mobile devices, such as mobile telephones. A camera processor can locate a cybercode tag and decode the data within the 2D barcode. Visual markers surrounding the barcode allow the processor to quickly locate the tag within the field of view of the camera. Additionally, the design of the CyberCode tag allows the processor to determine the tag's position.

The expression “cybercode-like pattern” as used in this document is intended to mean a cybercode pattern, or any pattern that may be displayed on a display of a provider device, that, on analysis of a part thereof, provides information as it to the location of that specific part of the pattern on the display of the provider device.

The system may include an analyzer, such as a computer or processor, that is arranged to analyze the captured part of the cybercode-like pattern in order to determine which portion of the display of the provider device that the camera arrangement captured data from, and to send a selection signal to the provider device, the selection signal indicating which portion of the display the camera captured data from. The provider device may be arranged to then send data originally displayed on the designated portion of the display to the requester device.

Exemplary embodiments may provide an easy and intuitive way to transfer any type of data that can be visually displayed or at least visually represented on a display device, using text or an icon for example, from one device to another, e.g., the contents of a file represented by a graphic symbol that suggests the type of object represented or the purpose of an available function, may be transferred from the display device of a provider device to a requestor device.

It should be noted that a cybercode-like pattern may be arranged to be displayed as well as at least a portion of the originally displayed data. A cybercode-like pattern, such as a digital watermark, may, for example, be displayed constantly together with the originally displayed data, for example, superimposed over the originally displayed data (in which case no trigger is necessary to inform the provider device that data is about to be captured from at least part of its display) or the cybercode-like pattern may be arranged to be temporarily displayed together with the originally displayed data. The cybercode-like pattern may include a pattern that is imperceptible to the naked eye but detectable using special equipment, such as an infra-red camera.

According some embodiments of the invention, the requester device and/or the provider device may include a portable or non-portable device, such as a telephone, media player, Personal Communications System (PCS) terminal, Personal Data Assistant (PDA), computer, palmtop receiver, camera, playstation (PS), Digital Versatile Disc (DVD), Electronic Program Guide (EPG), television, radar, or other electronic device.

According to some embodiments of the invention, the data may include visual data, such as text or image data, e.g., a picture or a map, or visually represented data, such as a file, a music file, for example, a computer program, or any combination thereof.

According to some embodiments of the invention, the trigger signal and/or the selection signal may be arranged to be transmitted wirelessly and/or non-wirelessly, such as via Bluetooth, Near Field Communication (NRC) or other technology.

According to some embodiments of the invention, the cybercode-like pattern generator may be arranged to display the cybercode-like pattern on the display of the provider device for less than a predetermined amount of time, for example, 3 seconds or, for example, for less than 2 seconds or, for example, for less than 1 second.

According to some embodiments of the invention, the system may include security features, for example, any conventional information security device or logic, to allow data displayed on the display device of the provider device to be transferred to approved users only, whereby data may be transferred between a provider device and a requester device in a secure and controlled manner.

According to some embodiments of the invention, the requester device may include a display device that is arranged to display the data originally displayed on at least a portion of the display device of the providing device and selectively captured by the camera, where at least a portion of the display device of the requester device is arranged to function as a user interface that allows a user to interact with the data displayed on the display device of the requester device, and/or to interact with the data displayed on the display device of the provider device.

According to some embodiments of the invention, the camera may form an integral part of the requester device. Alternatively, the camera may be a non-integral part of the requester device, whereby the camera is arranged to communicate with the requester device, whereby a single camera may be arranged to transmit data to a plurality of requester devices simultaneously.

According to some embodiments of the invention, the analyzer may form an integral part of the requester device or an integral part of the provider device. Alternatively, the analyzer may be a non-integral part of the requester device and a non-integral part of the provider device, whereby the analyzer is arranged to communicate with the requester device and/or the provider device.

The present invention may be directed to a requester device for use in a system according to any of the embodiments of the invention and a provider device for use in a system according to any of the embodiments of the invention.

The present invention may be directed to a provider device that includes a display device that is configured to display data, whereby the provider device includes a cybercode-like pattern generator that is configured to display a cybercode-like pattern on the display device instead of, or as well as the originally displayed data at least once, periodically, or at irregular intervals. The provider device may, for example, be configured to display data for 99% of the time and a cybercode-like pattern for 1% of the time during which the display device is activated. In the case where a cybercode-like pattern is displayed as well as other data, a provider device may be arranged to constantly display the cybercode-like pattern.

A system, device and method according to the present invention need not necessarily be configured to transmit a trigger signal to a provider device to inform the provider device that a requester device that includes a camera is capturing, or about to capture data, from at least a portion of its display. Alternatively, a provider device may be configured to at least once, periodically, or at irregular intervals, display a cybercode-like pattern on its display whereby a requester device that aims its camera at the provider device display while the cybercode-like pattern is being displayed will be able to transfer data from the display. Such an embodiment may, for example, be used at a trade fair where brochures/information about exhibits may be transferred from a provider device display at predetermined intervals, for example, when a (e.g., green) light located in the vicinity of the provider device display is flashing to indicate that data transfer is possible, without having to trigger the provider device display to display a cybercode-like pattern.

Embodiments of the present invention may be directed to a method for transferring data displayed on a display device of a provider device to a requester device. The method may include the steps of: displaying data on the display device of a provider device and capturing data from at least a portion of the display using a camera. A trigger signal may be transmitted to the provider device to inform the provider device that the camera is capturing, or about to capture data, from at least a portion of its display. The trigger signal may be used to synchronize the camera and the cybercode-like pattern generator so that a cybercode-like pattern is being displayed on the display device of the provider device while the camera is capturing data therefrom. The camera may capture at least a portion of the cybercode-like pattern instead of or as well as at least a portion of the originally displayed data.

A cybercode-like pattern may be displayed on the display device instead of or as well as the originally displayed data while the camera is capturing data from at least a portion of the display, whereby the camera may thereby capture at least a portion of the cybercode-like pattern instead of or as well as at least part of the originally displayed data. The captured part of the cybercode-like pattern may then analyzed to determine which portion of the display that the camera captured data from and a selection signal may be sent to the provider device, the selection signal indicating which portion of the display the camera captured data from. The provider device may then send data that was originally displayed on that selected part of the display to the requester device.

According to some embodiments of the invention, the requester device and/or the provider device may include a portable or non-portable device, such as a telephone, media player, Personal Communications System (PCS) terminal, Personal Data Assistant (PDA), computer, palmtop receiver, camera, playstation (PS), Digital Versatile Disc (DVD), Electronic Program Guide (EPG), television, radar, or any other appliance that includes a transducer designed to transmit and/or receive radio, television, microwave, telephone, and/or radar signals.

According to some embodiments of the invention, the data originally displayed on the display of the providing device may include visual data, such as text, an image, such as a picture or a map, or data depicted by a visual icon, a file, a music file or a computer program, or any combination thereof.

According to some embodiments of the invention, the method may include the step of transmitting the trigger signal and/or the selection signal wirelessly, such as via Bluetooth/Near Field Communication (NRC).

According to some embodiments of the invention, the method may include the step of displaying the cybercode-like pattern on the display of the provider device for a predetermined amount of time, for example, less than 3 seconds, less than 2 seconds, or less than 1 second.

According to some embodiments of the invention, the method may include the step of checking the identity of a user, using any conventional information security means to allow data displayed on the display device of the provider device to be transferred to approved users only.

According to some embodiments of the invention, the method may include the step of displaying the data originally displayed on at least a portion of the display device of the providing device and captured by the camera on a display device of the requester device and the step of transmitting data between the requester device and the provider device via the display device of the requester device, which may function as a user interface that allows a user to interact with the data displayed on the display device of the requester device and/or to interact with the data displayed on the display device of the provider device.

According to some embodiments of the invention, the method may include the steps of displaying data on the display device of a provider device and displaying a cybercode-like pattern on the display device instead of, or as well as the originally displayed data at least once, constantly, periodically, or at irregular intervals.

Some embodiments of the present invention may relate to a computer program product that includes a computer program containing computer program code means configured to cause a computer or a processor to execute the steps of a method according to any of the embodiments of the invention, stored on a computer-readable storage medium or a carrier wave. The invention may be used particularly, but not exclusively, for transferring data to a mobile telephone or between mobile telephones.

### BRIEF DESCRIPTION OF THE DRAWINGS

The present invention will hereinafter be further explained using non-limiting examples with reference to the appended figures.

FIGS. 1-5 illustrate data transfer in a system according to an embodiment of the invention;

FIGS. 6-9 illustrate data transfer in a system according to another embodiment of the invention; and

FIGS. 10 and 11 illustrate data transfer in a system according to a further embodiment of the invention.

It should be noted that the drawings have not necessarily been drawn to scale and that the dimensions of certain features may have been exaggerated for the sake of clarity.

### DETAILED DESCRIPTION OF EMBODIMENTS

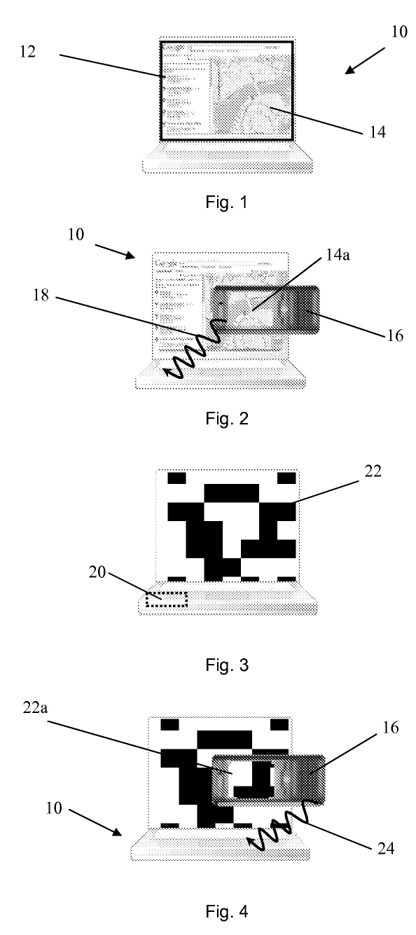

FIG. 1 shows a provider device 10, namely a computer, including a display 12 displaying visual data 14, for example, a map and text.

FIG. 2 shows a requester device 16, namely a mobile telephone, including a camera unit (not shown). In order to transfer data 14 displayed on display 12 of provider device 10 to a mobile telephone 16, a user may take a photograph of partial data 14a that is displayed on display 14 of provider device 10, e.g., a photograph of a specific part of the map in the illustrated embodiment. As a camera input device on mobile telephone 16 is activated, mobile telephone 16 may send a trigger signal 18, via Bluetooth or NFC, for example, to inform provider device 10 that someone in the vicinity of provider device 10 is capturing an image of at least portion of display 12.

A provider device, e.g., provider device 10, according to the present invention may be configured to request an approved user name and password and/or to check an identity of a user in some other manner before any data is transferred therefrom. Alternatively or additionally, a requester device, e.g., requester device 16, according to the present invention may be configured to request an approved user name and password and/or to check an identity of a user in some other manner before any data is transferred thereto.

Provider device 10 may include software, for example, that responds to trigger signal 18 so as to cause a cybercode-like pattern generator 20 to display a cybercode-like pattern 22 on display 12 of provider device 10 instead of originally or previously displayed data 14 while requester device 16 is taking a photograph of at least a portion of display 12, as illustrated in FIG. 3. Provider device 10 may temporarily displays cybercode-like pattern 22 on display 12 for approximately one second or less instead of the map and text shown in FIGS. 1 and 2.

FIG. 4 shows that, instead of capturing partial data 14a of the originally displayed data 14, requester device 16 may capture partial data 22a of cybercode-like pattern 22. Analysis of captured partial data 22a of cybercode-like pattern 22 may make it possible for the system according to the present invention to determine which portion of display 12 was selected by the user using requester device 16.

An analyzer disposed in provider device 10 and/or in requester device 16, or located remotely from both provider device 10 and requester device 16, may be used to analyze captured partial data 22a of cybercode-like pattern 22. The analyzer may be configured to send a selection signal 24 to provider device 10 to inform provider device 10 which portion of its display 12 that the image-capturing means of requester device 16 captured data from. Screen coordinates defining the selected part of display 12 may, for example, be sent to provider device 10 via Bluetooth or NFC. Provider device 10 may be configured to then send partial data 14a displayed on the selected portion of display 12 of provider device 10, to requester device 16, since it knows which portion of display 12 that the user selected.

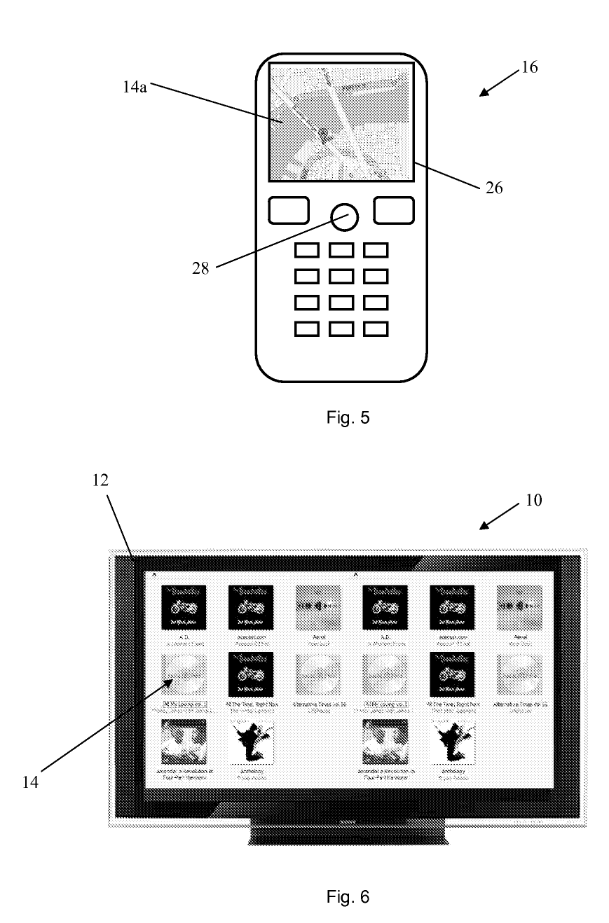

FIG. 5 shows requester device 16 displaying selected partial data 14a on its display 26, e.g., requester device 16 may display to the user that which was shown on the selected part of display 12 of provider device 10. Instead of the user receiving a blurry photograph, the user may receive a 1:1 digital copy of that which was shown on display 12 of provider device 10. Requester device 16 may then save or forward the received partial data 14a as an ordinary camera phone photograph, although received partial data 14a is of a much higher quality than an ordinary camera phone photograph.

FIG. 5 also shows requester device 16 including a button 28 associated with a camera arrangement which, when activated, causes cybercode-like pattern generator 20 to simultaneously display cybercode-like pattern 22 via display 12 of provider device 10 as part of display 12, is photographed by an image-capturing device of requester device 16. Once an image has been captured, display 12 of provider device 10 may, of course, continue to display originally displayed data 14.

FIG. 6 shows provider device 10, a television, including screen 12 displaying data 14 in the form of a plurality of albums, e.g., music files, each visually represented by an icon.

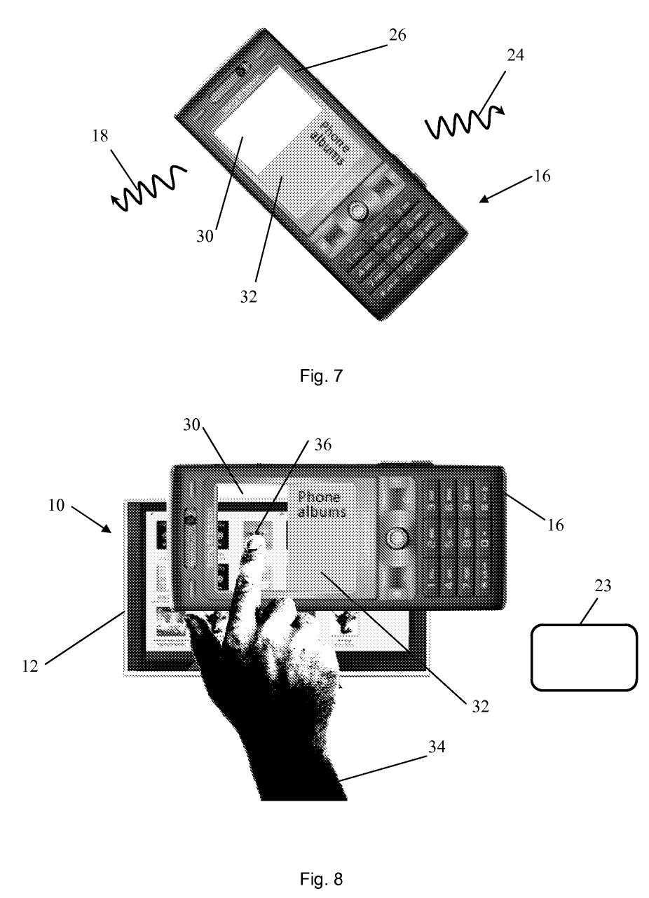

FIG. 7 shows requester device 10, a mobile phone, including display 26 and a camera unit (not shown). Approximately one-half of display 12 in the illustrated embodiment may function as a viewfinder 30 and the other one-half of display 12 may function as a user interface 32. Viewfinder 30 of requester device 16 may be used to select a portion of display 12 of provider device 10, whereby a user may choose to zoom in or zoom out in order to select a particular portion of data 14 being displayed on display 12 of the associate provider device. Requester device 16 may include means to transmit trigger signal 18 and selection signal 24 to the associated provider device so that partial data 14a that is displayed via display 12 of provider device 10 may be transmitted to viewfinder 30 of display 26 of requester device 16, for example, in the same manner as described above with reference to FIGS. 1-5.

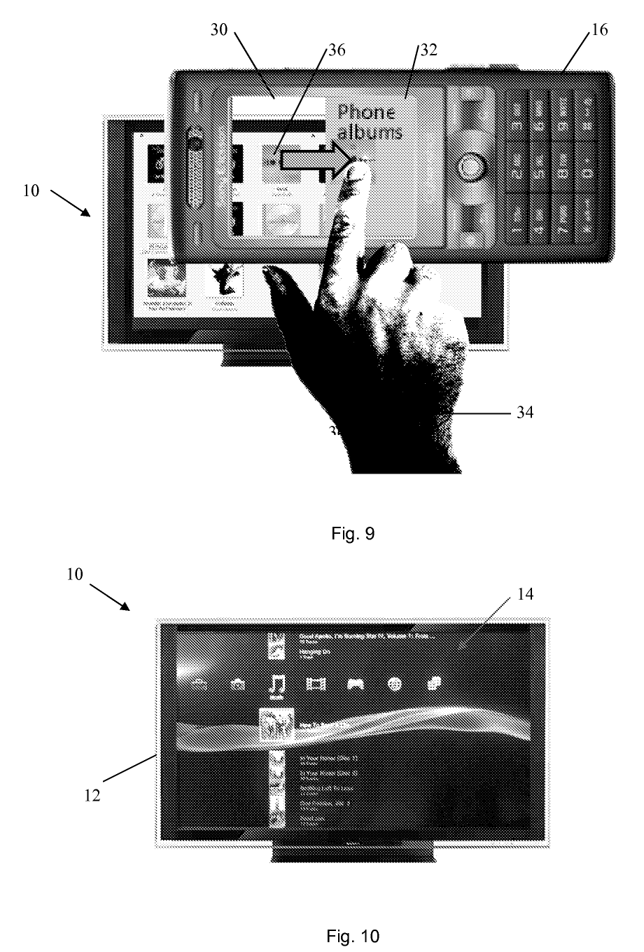

FIGS. 8 and 9 show that a user 34, upon receiving partial data 14a selected from display 12 of provider device 10, may simply select an album 36 from a number of albums being displayed on viewfinder 30 of display 26 of mobile phone 16 and drag and drop it in user interface 32 of display 26. User 34 may then choose to play music associated with album 36 on provider device 10 and/or on requester device 16. FIG. 8 also shows analyzer 23 that is located remotely from both provider device 10 and requester device 16, which is used to analyze the captured portion of a generated cybercode-like pattern to determine which portion of display 12 of provider device 10 that the camera unit of requester device 16 captured data from and to send a selection signal to provider device 10, the selection signal indicating which portion of display 12 of provider device 10 that the camera captured data from.

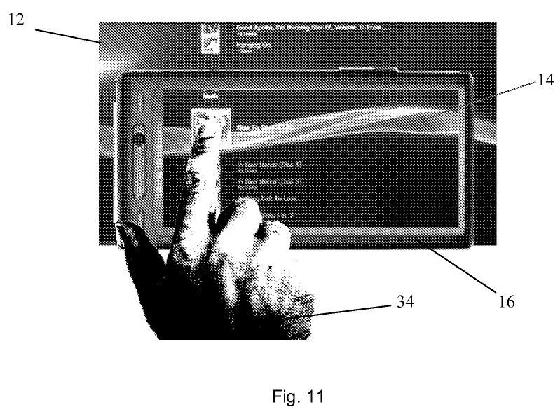

FIG. 10 shows display 12 of provider device 10 such as a television, projector, computer, Playstation (PS), Digital Versatile Disc (DVD), Electronic Program Guide (EPG), or any other device, which is displaying data 14. Display 12 may function as a user interface, such as a touch screen that can detect the location of touches within the display area. This allows display 12 to be used as an input device, thus avoiding the need control buttons, a keyboard and/or a mouse as the primary input device for interacting with the display's content.

FIG. 11 shows that user 34 may interact with (touch screen) display 12 using a system according to the present invention, without having to touch display 12. Data 14 that is displayed on display 12 of provider device 10, i.e., the user interface, may namely be transmitted to display 26 of an associated requester device 16 in the manner described above with reference to FIGS. 1-5. User 34 may then interact with the user interface displayed on requester device 16, whereby inputted instructions may then be transmitted from requester device 16 to provider device 10.

Further modifications of the invention within the scope of the claims would be apparent to a skilled person.

1-17. (canceled)

18. A system comprising:
a first device including:
a display,
a receive unit to receive a trigger signal from a second device indicating that the data displayed on at least a portion of the display is to be captured, and
a cybercode-like pattern generator to render, via the display, a cybercode-like pattern, wherein at least part of the cybercode-like pattern is to be captured along with the data displayed on the at least a portion of the display; and
an analyzer to:
determine, based on the captured part of the cybercode-like pattern, the at least a portion of the display associated with the captured data, and
provide, to the first device, a selection signal indicating the at least a portion of the display, wherein the first device is configured to send the captured portion of the data to the second device.

19. The system of claim 18, wherein the first device is at least one of a telephone, a media player, a personal communications system (PCS) terminal, a personal data assistant (PDA), a computer, a palmtop receiver, a camera, a playstation (PS), a digital versatile disc (DVD), an electronic program guide (EPG), a television, or a radar.

20. The system of claim 18, wherein the data comprises at least one of visual data or visually represented data.

21. The system of claim 18, wherein at least one of the trigger signal or the selection signal is configured to be transmitted via Bluetooth or near field communication (NRC).

22. The system of claim 18, wherein the cybercode-like pattern generator is configured to render the cybercode-like pattern via the display of the first device for 3 seconds or less.

23. The system of claim 18, wherein the first device comprises the analyzer.

24. The system of claim 20, wherein the visual data comprises at least one of text or an image.

25. The system of claim 20, wherein the visual data comprises at least one of a file or a computer program.

26. The system of claim 18, wherein the cybercode-like pattern generator is configured to render the cybercode-like pattern via the display at least once, constantly, periodically, or at irregular intervals.

27. A method comprising:
displaying data via a display of a first device,
receiving a trigger signal at the first device indicating that a second device is to capture data from at least a portion of the displayed data from at least part of the display;
rendering a cybercode-like pattern via the display, wherein at least a portion of the cybercode-like pattern is to be captured along with the data displayed on the at least a portion of the display;
analyzing the captured part of the cybercode-like pattern to determine the at least a portion of the display; and
receiving a selection signal at the first device, the selection signal indicating the at least a portion of the display, wherein the first device is configured to send the captured portion of the data to the second device.

28. The method of claim 27, wherein the first device comprises at least one of a telephone, a media player, a personal communications system (PCS) terminal, a personal data assistant (PDA), a computer, a palmtop receiver, a camera, a playstation (PS), a digital versatile disc (DVD), an electronic program guide (EPG), a television, or a radar.

29. The method of claim 27, wherein the data comprises at least one of visual data or visually represented data.

30. The method of claim 27, wherein the transmitting at least one of the trigger signal or the selection signal comprises transmitting via Bluetooth or near field communication (NRC).

31. The method of claim 27, wherein the rendering the cybercode-like pattern comprises rendering the cybercode-like pattern via the display of the first device for 3 seconds or less.

32. The method of claim 27, wherein the analyzing is performed by the first device.

33. The method of claim 27, wherein the rendering the cybercode-like pattern via the display comprises rendering the cybercode-like pattern at least once, constantly, periodically or at irregular intervals.

34. A computer-readable medium having computer-executable instructions stored thereon, comprising:
instructions to transmit a trigger signal to a first device indicating that a second device is to capture data displayed on at least a portion of a display of the first device;
instructions to capture the displayed data along with a cybercode-like pattern rendered via the display;
instructions to analyze the captured cybercode-like pattern to determine the at least a portion of the display; and
instructions to transmit a selection signal to the first device, the selection signal indicating the at least a portion of the display, wherein the second device is configured to receive the captured data.
